(19) United States
(12) Patent Application Publication
(10) Pub. No.: US 2003/0093814 A1
(43) Pub. Date: May 15, 2003

(54) System and method for generating user-specific television content based on closed captioning content

(76) Inventor: Blair B.A. Birmingham, Toronto, CA (US)

Correspondence Address: TOLER & LARSON & ABEL L.L.P., PO BOX 29567, AUSTIN, TX, 78755-9567, US

(21) Appl. No.: 10/039,436

(22) Filed: Nov. 9, 2001

(51) Int. Cl. H04N 7/16

(52) U.S. Cl. 725/136; 725/139; 725/1; 725/63

(57) ABSTRACT

A system and method for generating and delivering user-specific content from one or more television broadcasts based on closed captioning contents of the television broadcasts are disclosed herein. One or more sets of television content, representative of one or more television channels, multimedia channels, and the like, are received by a content distributor. The content distributor, in one embodiment, decodes the closed captioning contents of the television content. Using a set of parameters defined by a user or an administrator, the content distributor, in one embodiment, generates user-specific content, such as a text transcript, a still image, an audio clip and/or a video clip from a portion of the television broadcast. In one embodiment, the set of parameters includes one or more keywords. In this case, the content distributor searches the closed captioning content of one or more specified channels for the one or more keywords, and if found, generates user-specific content based on the location of the found keywords within the closed captioning content. In another embodiment, the set of parameters includes one or more specified channels, times and/or date combinations. When a specified date and/or time has occurred, the content distributor, in one embodiment, generates user-specific content from a portion of the television content associated with the specified channel. For example, a user could specify a television channel number, time and date of the user's favorite network television channel. At the specified time and date, the content distributor generates a text transcript (the user-specific content) from the television broadcast on the specified channel. After generating the user-specific content, the content distributor can transmit the user-specific content to the user's receiving device, such as an alphanumeric pager, a wireless phone, a handheld computing device, and the like.

### FIELD OF THE DISCLOSURE

The present invention relates generally to processing television content and more particularly to the distribution of user-specific television content.

### BACKGROUND

Various devices have been developed to store television content for users when they are unable to watch a television broadcast. For example, a number of set top boxes have been developed that record television content onto a storage device, such as a hard disk, that the user can access at a later time for viewing. However, a number of limitations arise with these devices. One limitation of these devices is that a user must actively retrieve the stored television content. Instead of having the desired content sent to the user in a specified format, the user generally has to access the set top box and select the recorded content to be displayed. For example, if a user were to select a particular television program to be recorded, the user would have to return to the set top box at a later time and play the recorded television program, causing an inconvenience to the user. Another limitation common to these devices is that the stored television content is not readily customized to a user's preferences. Although the user may specify a particular program or a particular time and television channel to record, the user is often only interested in a portion of the recorded content. In order to find this portion, the user may have to spend needless time searching for the portion. For example, if a user were to specify a news program to be recorded, but was only interested in recording a news story about a certain subject, the user might have to watch (or scan) almost the entire program before the desired news story was displayed. Yet another limitation is that the television content is not accessible on a real-time basis. Users generally must wait until they are able to reach the recording device to retrieve the television content for viewing, rather than having the content sent to the user as it is broadcast.

Given these limitations, as discussed, it is apparent that an improved system and/or method for timely delivery of television content would be advantageous.

### BRIEF DESCRIPTION OF THE DRAWINGS

Various objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification.

FIG. 1 is a block diagram illustrating a television content distribution system according to at least one embodiment of the present invention;

FIG. 2 is a diagram illustrating a user interface used to input user-defined parameters according to at least one embodiment of the present invention;

FIG. 3 is a block diagram illustrating a content distributor according to at least one embodiment of the present invention;

FIG. 4 is a flow diagram illustrating a method for generating and distributing user-specific content according to at least one embodiment of the present invention; and

FIG. 5 is a block diagram illustrating a particular embodiment of the television content distribution system illustrated in FIG. 1 according to at least one embodiment of the present invention.

### DETAILED DESCRIPTION OF THE FIGURES

In accordance with at least one embodiment of the present invention, television content including closed captioning content is received. A first portion of the television content is identified based on the closed captioning content. Content associated with the first portion of the television content is provided to a remote device. One advantage in accordance with a specific embodiment of the present invention is that a user can passively receive desired information in a timely manner. Another advantage is that television content can be customized according to user specified preferences.

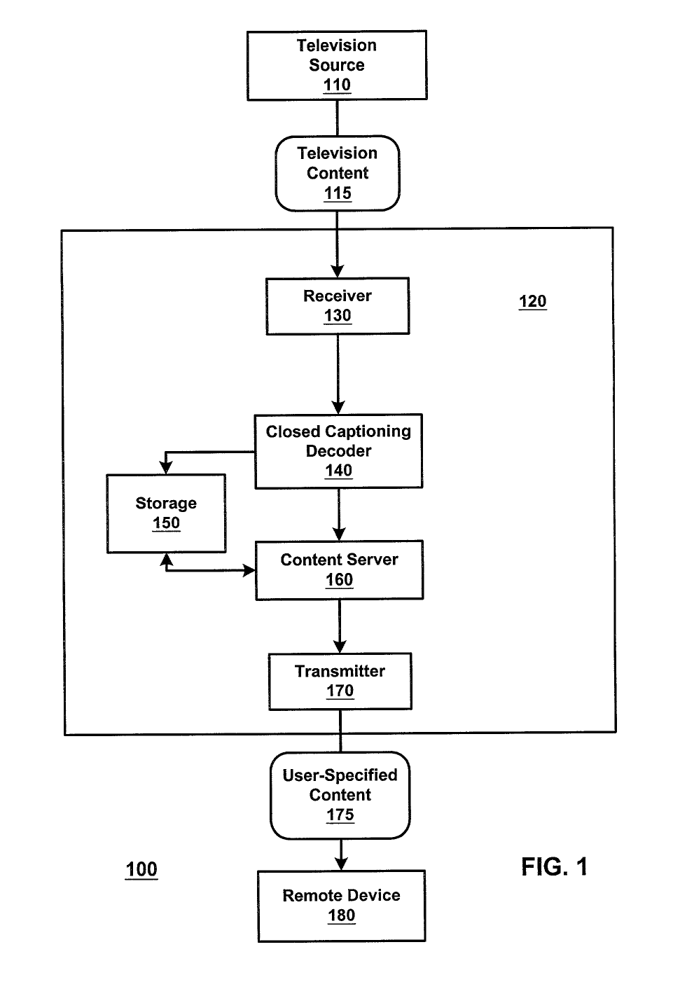

FIGS. 1-5 illustrate a system for generating and delivering user-specific content from one or more television broadcasts based on closed captioning contents of the television broadcasts, as well as a system for its use. One or more sets of television content, representative of one or more television channels or signals, multimedia channels, and the like, are received by a content distributor. The content distributor, in one embodiment, decodes the closed captioning contents of the television content. Using a set of parameters defined by a user or an administrator, the content distributor, in one embodiment, generates user-specific content, such as a text transcript, a still image, an audio clip and/or a video clip from a portion of the television broadcast. In one embodiment, the set of parameters includes one or more keywords. In this case, the content distributor searches the closed captioning content of one or more specified channels for the one or more keywords, and if found, generates user-specific content based on the location of the found keywords within the closed captioning content. In another embodiment, the set of parameters includes one or more specified channels, times and/or date combinations. When a specified date and/or time has occurred, the content distributor, in one embodiment, generates user-specific content from a portion of the television content associated with the specified channel. For example, a user could specify a television channel number, time and date of the user's favorite network television channel. At the specified time and date, the content distributor generates a text transcript (the user-specific content) from the television broadcast on the specified channel. After generating the user-specific content, the content distributor can transmit the user-specific content to the user's receiving device, such as an alphanumeric pager, a wireless phone, a handheld computing device, and the like.

Referring now to FIG. 1, a system for transmission of television content based on a closed captioning content of a television broadcast is illustrated according to at least one embodiment of the present invention. Distribution system 100 includes television source 110, content distributor 120, and remote device 180. Content distributor 120 includes receiver 130, closed captioning decoder 140, storage 150, content server 160, and transmitter 170.

In at least one embodiment, television source 110 transmits television content 115 to content distributor 120. Television source 110 can include a variety of multimedia sources or players, such as a television broadcaster, digital cable, satellite cable, a digital versatile disc (DVD) player, and the like. Television content 115, in one embodiment, includes data or television signals representative of one or more channels of television content transmitted from television source 110 having a closed captioning content. Television content 115 can include any type of display content or signal, such as video, having closed captioning content. For example, television source 110 could include a television broadcaster that transmits a number of network television channels (television content 115) having closed captioning content embedded in each television channel. Likewise, television source 110 could include a DVD player that transmits data representative of a movie (television content 115) having closed captioning content-to-content distributor 120. Content distributor 120 can include a information processing system, such as a personal computer, a set top box for a television, one or more Internet servers, and the like. For example, content distributor 120 could include a plurality of Internet servers maintained by a company which provides television content to subscribers based on subscriber-specified information.

Content distributor 120, in one embodiment, receives television content 115 using receiver 130. Receiver 130 can include any system or device necessary to receive and format television content 115 for use by content distributor 120, such as a radio antenna, a satellite receiver, a cable set top box, a network card connected to a network, and the like. For example, if television content 115 is transmitted as a television (radio) signal, such as a network television broadcast, receiver 130 could include a radio antenna to receive television content 115 and an analog-to-digital convertor to convert television content 115 from an analog format to a digital format. After any necessary formatting, receiver 130 sends television content 115 to closed captioning decoder 140.

Closed captioning decoder 140, in one embodiment, decodes the closed captioning content from television content 115. For example, when using the National Television Standards Committee (NTSC) format for television signals, closed captioning content is incorporated into line 21 during the vertical blanking interval. In this case, closed captioning decoder 140 could isolate the closed captioning content during the vertical blanking interval and convert it to text in a digital format. In one embodiment, the text output of closed content decoder 140 is stored in storage 150. Storage 150 can include a variety of storage devices, such as memory, a hard disk, an optical disc, removable storage, and the like. In other embodiments, the text representative of the closed captioning content is transmitted directly to content server 160. Note that, in at least one embodiment, reference to “closed captioning” includes reference to a variety of video subtitling protocols, such as the American closed captioning system, the Teletext system implemented in the United Kingdom, the Antiope system used in France, and the like.

Content server 160, in one embodiment, utilizes the closed captioning content of television content 115 to generate user-specific content 175. Content server 160, in one embodiment, uses a set of parameters, indicated by a user or otherwise, to analyze the text representative of the closed captioning content to generate user-specific content 175 based on the analyses. For example, in one embodiment, the set of parameters includes one or more keywords, where the keywords can include a single word, a phrase, and the like. In this case, content server 120 can search the closed captioning content for a keyword. If the keyword is found, then content server 160 can generate user-specific content 175 based on the location of the keyword within the closed captioning content. For example, user-specific content 175 could include a text transcript of a television broadcast (television content 115) generated from the closed captioning text. In addition to a text transcript, user-specific content 175 could also include a still image, a video clip, an audio clip, and the like.

In another embodiment, the set of parameters used to specify desired user-specific content could include a specified time and/or date for a specific channel, such as a television channel. In this case, content server 160 could generate user-specific content 175 from the closed captioning content of the specified channel at the specified time and/or date. For example, if the set of parameters specify a certain network news television channel that broadcasts a financial program at 8:00 PM every Wednesday, content server 160 could generate a text transcript (user-specific content 175) of the financial program from a portion of text representative of the closed captioning content. Content server 160 is discussed in greater detail subsequently.

Transmitter 170, in one embodiment, formats user-specific content 175, as appropriate, and transmits user-specific content 175 to remote device 180 using an appropriate medium. Transmitter 170 can include a radio transmitter, a satellite transmitter, a network interface connected to a network, an infrared transmitter, and the like. Remote device 180 can include a variety of remote devices capable of receiving user-specific content 175, an alphanumeric pager, a handheld wireless computing device, and the like. For example, in at least one embodiment, remote device 180 includes a wireless device, such as a pager or a handheld computing device. In this example, transmitter 170 could include a radio transmitter used to transmit user-specific content 175 to remote device 180 in a radio format. Similarly, remote device 180 can also include a remotely connected information processing system. For example, remote device 180 could include a desktop computer connected to content distributor 120 via the Internet.

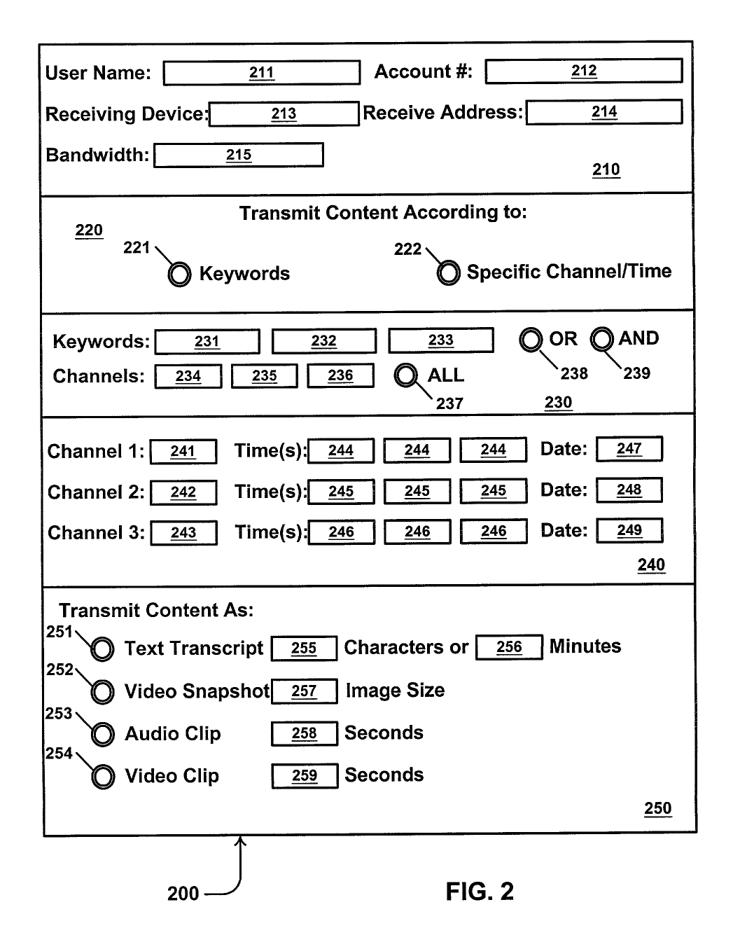

Referring next to FIG. 2, a user interface used to obtain user-specified parameters is illustrated according to at least one embodiment of the present invention. As discussed previously, in at least one embodiment, user-specific content 175 (FIG. 1) is generated based on, at least in part, parameters developed from user preferences. In one embodiment, the parameters are developed using user input, such as by using user interface 200. In other embodiments, the parameters are developed without direct user input, such as by analyzing the user's viewing patterns.

User interface 200, in one embodiment, is utilized by content distributor 120 (FIG. 1) to obtain parameters indicated by the user. The parameters, in turn, can be used by content distributor 120 (FIG. 1) to generate user-specific content 175 (FIG. 1) according to the parameters. User interface 200 includes user information section 210, selection-method section 220, keyword section 230, specific date/time section 240, and transmission parameters section 250. User interface 200 can include a webpage or website on the Internet, a graphical user interface (GUI) on a user's computer or set top box, a GUI on a remote device 180 (FIG. 1), a paper form, and the like.

User information section 210 includes user name field 211, account number field 212, receiving device field 213, receive address field 214, and bandwidth field 215. User name field 211 can be used to record or store the user's name or a user pseudonym. For example, a user with the name of John Doe could input the name “John Doe” or “jdoe” into user name field 211. Likewise, account number field 212 could be used to record the user's account number for various purposes, such as maintenance, billing, and the like. It will be appreciated that the type, make and/or model of remote device 180 (FIG. 1) could be important for formatting purposes. For example, the format of user-specific content 175 could be different for a two-way pager versus a messaging system for a wireless phone. Accordingly, receiving device field 213 can be used to store the type, make and/or model of remote device 180 used by the user to receive user-specific content 175. For example, if remote device 180 includes a Motorola™ T900 two-way pager, the user could select or enter “Motorola T900” into receiving device field 213. Alternately, the type, make and/or model for remote device 180 could be preselected according to data supplied by the user previously.

Similarly, bandwidth field 215 can be used to indicate the maximum bandwidth capability of remote device 180. It will be appreciated that, like type of remote device 180, the bandwidth of remote device 180 may limit or determine the format of user-specific content 175. For example, if the bandwidth indicated in bandwidth field 215 is 14.4 kilobits per second, transmitting a video clip could be deemed as prohibitively slow, thereby limiting the types of user-specific content 175 sent to remote device 180 to less data-intensive formats, such as text transcripts and still images. The value of bandwidth field 215, in one embodiment, is automatically set depending on the type of receiving device 180 (FIG. 1) entered into receiving device field 213. Receive address field 214 can be used to indicate the address or location of remote device 180 to which user-specific content 175 is to be transmitted, such as an Internet protocol (IP) address, an e-mail address, a telephone number, and the like.

Selection-method section 220 includes keyword button 221 and specific channel/time button 222. As discussed previously, a variety of methods can be used by content distributor 120 (FIG. 1) to generate user-specific content 175 (FIG. 1) based on a closed captioning content. A method for generating user-specific content 175 based on a search of the closed captioning content using one or more keywords may be selected by selecting keyword button 221. A method for generating user-specific content 175 based on a specified channel, time and/or date can be selected using specific channel/time button 222. In one embodiment, both methods may be used simultaneously, i.e. a user can select both keyword button 221 and specific channel/time channel 222.

In the event that a user indicates a desire to receive user-specific content 175 (FIG. 1) based on a keyword search, the user can use keyword section 230 to input keyword preferences. Keyword fields 231-233 can be used to enter single words and/or phrases. “Or” button 238 and “And” button 239 can be used to indicate the preferred Boolean search method to be used to search for a plurality keywords entered into keyword fields 231-233. For example, if a user were to select “Or” button 238, the closed captioning content of television content 115 (FIG. 1) could be searched for any instance of any of the keywords indicated by keyword fields 231-233. Conversely, if a user were to select “And” button 239, the closed captioning content of television content 115 could be searched for an instance where all of the keywords indicated by keyword fields 231-233 are present. Search channel fields 234-236 can be used by the user to indicate which channels are to be searched for the keywords indicated in keyword fields 231-233. For example, if television content 115 included data representative of a plurality of television channels, the user could select those of the plurality of television channels that are to be searched for the one or more keywords. “All” button 237 can be selected by the user to indicate that all available channels are to be searched.

Note that the term “channel”, as used herein, refers to an individual or independent source of display content. For example, the term “channel”, when used in the context of a television broadcast, refers to an individual television channel, such as “channel 19” on a television. Likewise, the term channel can also refer to one input of a plurality of inputs from one or more television sources 110 (FIG. 1). For example, if distribution system 100 (FIG. 1) includes three DVD players (television sources 110), the output from each of the three DVD players could be considered a “channel”.

In the event that a user desires to receive user-specific content 175 (FIG. 1) based on a specified channel, date, and/or time, the user can utilize specific date/time section 240 to input channel, date, and/or time parameters. Specific date/time section 240 includes specific channel fields 241-243, time fields 244-246, and date fields 247-249. Specific channel fields 241-243 can be used to indicate specific channels as sources for user-specific content 175. For example, the user could select one or more television channels included in television content 115. The user can then indicate specific times for generation of user-specific content 175 using the corresponding time fields 244-246, as well as desired dates in date fields 247-249. Time fields 244-246 can include a specific time span, such as “8:30 AM-9:00 AM”, an entry field where a user can enter a time span, and the like. Time fields 244-246 could also include a selection of programs specific to the channel selected in the corresponding specific channel field 244-246. For example, if a user selected or entered a news channel into specific channel field 244, time fields 244 could have a number of program entries, such as a “breaking news” entry, a “financial report” entry, a “international news” entry, etc. The user could then select one or more of these entries using one or more of time fields 244. Date fields 247-249 can be used to select a specific date or a recurring date. For example, a user could input or select a specific date, such as “Dec. 3, 2001 ” or the user could select a recurring date, such as “every Wednesday”, and the like.

In addition to selecting the parameters by which user-specific content 175 (FIG. 1) is generated based on the closed captioning content of television content 115 (FIG. 1), in one embodiment, a user may specify the format of user-specific content 175 using transmission parameters section 250. Transmission parameters section 250 includes text transcript button 251, video snapshot button 252, audio clip button 253, video clip button 254, character count field 255, text minutes field 256, image size field 257, audio seconds field 258, and video second field 259.

If a user desires to receive user-specific content 175 (FIG. 1) in the form of a text transcript, the user can select text transcript button 251. The user can further revise the format of the text transcript (one embodiment of user-specific content 175) by indicating the maximum number of characters to be included in the text transcript using character count field 255. Similarly, the user may indicate the number of minutes of the multimedia transition to be included in the text transcript (user-specific content 175) using text minutes field 256. For example, the user could enter “thirty minutes” into text minutes field 256, resulting in thirty minutes worth of a text transcript of a channel transmitted as user-specific content 175.

Likewise, if a user desires to receive user-specific content 175 (FIG. 1) as a still image snapshot, the user may select video snapshot button 252. The size of the still image (user-specific content 175) can be indicated by the user using image size field 257, where the size can be indicated in terms of resolution, data size, and the like. Likewise, a user could select user-specific content to be transmitted as an audio clip by selecting audio clip button 253 or transmitted as a video clip by selecting video clip button 254. The desired length of an audio clip (one embodiment of user-specific content 175) can be indicated by audio seconds field 258, and the desired length of a video clip can be indicated by video seconds field 259. In at least one embodiment, user-specific content 175 can include more than one type of content. For example, a user could select text transcript button 251 and video clip button 254. In this case, user-specific content 175 could include both a text transcript and a video clip.

It will be appreciated that the format of user-specific content 175 (FIG. 1), in one embodiment, is limited by the capabilities and/or characteristics of remote device 180 (FIG. 1). Accordingly, in at least one embodiment, one or more elements of transmission parameters section 250 may be disabled. For example, alphanumeric pagers (one embodiment of remote device 180) are generally incapable of displaying video still images, video clips, and audio clips. Therefore, in this example, video snapshot button 252, audio clip button 253, and video clip button 254 could be disabled. Likewise, the bandwidth (as indicated by bandwidth field 215) may prohibit the transmission of user-specific content 175 in a data-intensive format, such as a lengthy video clip.

User interface 200, in one embodiment, is implemented as a graphical user interface (GUI) run on an information processing system, such as a personal computer. For example, user interface 200 could include a website on the World Wide Web. In this example, a user, using a web browser on a computer connected to the World Wide Web, could log onto the website (user interface 200) and enter the desired parameters into the corresponding fields, as discussed previously. The user could then submit the parameters for use in determining user-specific content 175 (FIG. 1) to be transmitted to remote device 180 (FIG. 1).

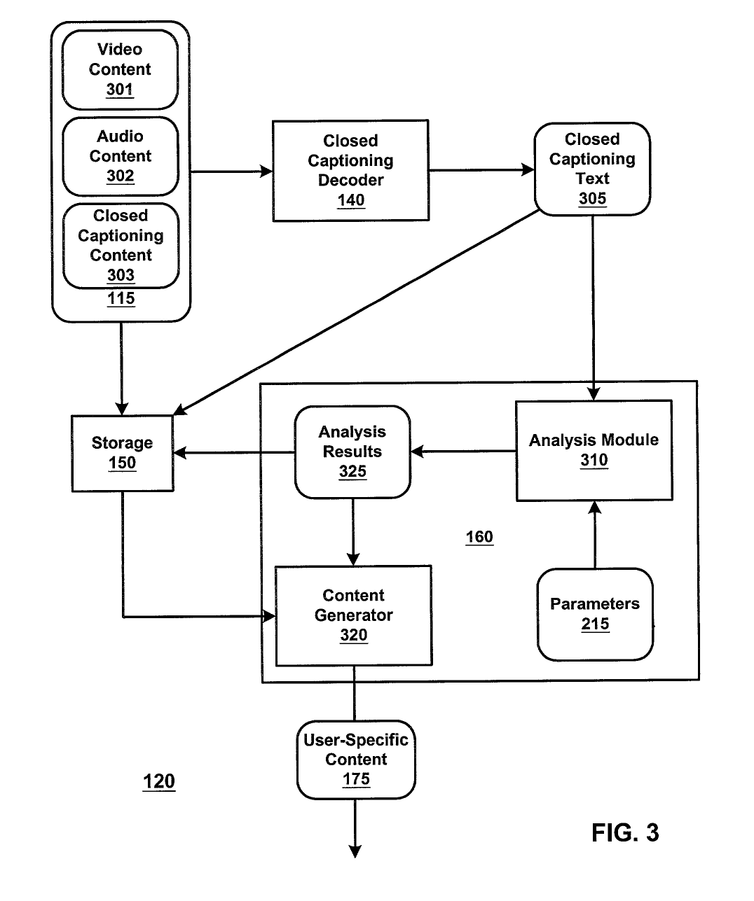

Referring to FIG. 3, content distributor 120 is illustrated in greater detail according to at least one embodiment of the present invention. As discussed previously, in at least one embodiment, television content 115 is received by content distributor 120, where the closed captioning content is decoded and used to generate user-specific content 175. Television content 115, in at least one embodiment, includes video content 301, audio content 302, and closed captioning content 303. Video content 301 can include visual information, such as video, still images, and the like. Audio content 302 can include audio information, such as an audio track associated with video content 301. Closed captioning content 303 includes subtitling information, such as closed captioning, Teletext, and the like. It will be appreciated that in one embodiment, video content 301 includes closed captioning content 303. For example, according to the NTSC protocol, closed captioning content 303 is transmitted through line 21 during the vertical blanking interval of a television transmission. All or part of television content 115, in one embodiment, is stored in storage 150.

Closed captioning decoder 140, in one embodiment, extracts closed captioning content 303 from television content 115 and converts it into closed captioning text 305. For example, if television content 115 is a television broadcast or signal, closed captioning decoder 140 could isolate closed captioning content 303 and then convert closed captioning content 303 from an analog signal representing a visual display of the closed captioning content into text data (closed captioning text 305) that is capable of being processed by content server 160. Closed captioning text 305 may be stored in storage 150 or sent directly to content server 160.

Closed captioning decoder 140 can be implemented using software, hardware, or a combination thereof. For example, closed captioning decoder 140 could include an analog to digital converter to convert an analog television signal (television content 115) into a digital format which is then converted into closed captioning text 305 using a set of software instructions executed on a processor (not shown). Alternately, television content 115 could be transmitted to content distributor 120 in a digital format. For example, television content 115 could include multimedia data originating from the Internet in a digital format. In this example, closed captioning decoder 140 could be implemented entirely in software. It will be appreciated that in embodiments where closed captioning content 303 is already decoded into closed captioning text 305 before being received by content distributor 120, closed captioning decoder 140 can be omitted without departing from the spirit or the scope of the present invention.

Content server 160, in at least one embodiment, analyzes closed captioning text 305 using parameters 315. Parameters 315 can be determined by an administrator, a user, and the like. Recall that, in one embodiment, a user can utilize user interface 200 (FIG. 2) to input and select user-specified parameters (parameters 315). Parameters 315, as discussed previously with reference to FIG. 2, can include specifications for remote device 180 (FIG. 1), keywords, specific channels/times/dates, types of user-specific content 175, and the like.

Analysis module 310, in one embodiment, performs an analysis of closed captioning text 305 using parameters 315. For example, if a user desires to receive a text transcript (user-specific content 175) of a television program where one or more specific words or phrases (keywords) are used, the user may indicate these keywords as part of parameters 315, as well as which television channels to search for that keyword. Analysis module 310, in one embodiment, searches for the one or more keywords within closed captioning text 305. Closed captioning text 305 can be stored in a database (storage 150) for later retrieval by analysis module 310. For example, a user could indicate that the user desires to have a text transcript (user-specific content 175) of any program during a certain week having a specific keyword sent to remote device 180 (FIG. 1). Accordingly, analysis module 310 retrieves closed captioning text 305 for the specified week from the database (storage 150) and searches the results for the specific keyword. Alternately, in one embodiment, closed captioning text 305 is searched on a real-time basis, wherein closed captioning text 305 is searched for the one or more keywords as closed captioning text 305 is decoded by closed captioning decoder 140.

In one embodiment, the results of the search are output as analysis results 325. In this case, analysis results 325 can include one or more locations or the one or more keywords within closed captioning text 305. These one or more locations could be recorded as a time and channel. For example, if the keyword “China” was found in the closed captioning text 305 associated with a specific television channel (channel 25, for example) at a location corresponding to the time of 8:31.15 AM (or 0831.15 on a 24 hour clock) of the television channel transmission, analysis results 325 could include a data entry that includes the found keyword, the television channel number, and the corresponding time location, i.e.: “China”, channel 25, 0831.15, and so on. Similarly, the one or more locations could be recorded as a location relative to storage 150, such as a location of the found word in a database used to store closed captioning text 305. Other formats for indicating the location of a found keyword within closed captioning text 305 can be used without departing from the spirit or the scope of the present invention.

Rather than searching closed captioning text 305 for one or more keywords, in one embodiment, user-specific content 175 is generated based on a specified channel, time and/or date. For example, a user could specify a channel, date, and time, as discussed previously. In this case, analysis module 310 extracts the necessary parameters from parameters 315 and output them as analysis results 325. Similarly, in one embodiment, closed captioning text 305 can be searched for one or more keywords occurring in content received on specified date on a specified channel at a specified time.

Content generator 320, in at least one embodiment, utilizes analysis results 325 and television content 115 to generate user-specific content 175. As discussed previously, user-specific content 175 may be generated as a result of a search for one or more keywords (such as by selecting keyword button 221, FIG. 2) within closed captioning text 305 or generated from parameters indicating a specific channel, time and/or date (such as by selecting specific channel/time button 222, FIG. 2). Likewise, the format of user-specific content 175, such as a text transcript, a still image, an audio clip, and/or a video clip, is indicated using parameters 315.

In the case where user-specific content 175 is to be generated as a result of a keyword search, content generator 120, in one embodiment, uses the one or more locations indicated by analysis results 325 to generate user-specific content 175 from a portion of television content 115. For example, if a keyword was located within closed captioning text 305 and the user indicated (using user interface 200, FIG. 2, for example) that user-specific content 175 should be sent as a text transcript having a maximum length of 600 characters, content generator 320 could select the 300 characters of closed captioning text 305 located immediately previous to the location of the found keyword and the 295 characters located immediately subsequent to the location of the found keyword (assuming the keyword is five characters in length). The selected characters containing the keyword can then be output as user-specific content 175 in the appropriate format. Likewise, if a user indicated that user-specific content 175 should be sent as video snapshot, content generator 320 could retrieve a frame of video or a still image from video information 301 stored in storage 105, where the frame or still image selected corresponds to the location of the found keyword (indicated as part of analysis results 325). Similarly, an audio clip or video clip corresponding to the location of the found keyword can be sent as user-specific content 175. Recall that the length of the audio clip and video clip, in one embodiment, are determined using audio seconds field 258 and video seconds field 259, respectively. Note that, in one embodiment, user-specific content 175 can include more than one content format. For example, user-specific content 175 could include both a video clip and a text transcript.

In the case where user-specific content 175 is to be generated based on specified channel, time and/or date parameters, content generator 320, in one embodiment, selects a portion of television content 115 (FIG. 1) using the specified parameters. If the specified time and/or date has already passed at the time content generator 320 receives analysis results 325, content generator 320, in one embodiment, can retrieve the desired content indicated by the specified parameters from storage 150. For example, if user-specific content 175 is to include a text transcript from television channel 25 starting at 12:00 AM on a previous Thursday and ending at 12:30 AM, content generator 320 could retrieve closed captioning text 305 from storage 105 corresponding to the specified channel, start and end times, and date. If the specified time and/or date have yet to pass at the time content generator 320 receives analysis results 325, content generator 320, in one embodiment, waits idle until the specified time/date has arrived unless another request to generate a different user-specific content 175 is received by content generator 320. As with user-specific content 175 generated by content generator 320 as a result of a keyword search, content generator 320 can generate a still image, video clip and/or audio clip (user-specific content 175) based on specified parameters.

Content generator 120, in one embodiment, also converts user-specific content 175 into the appropriate format. For example, if user-specific content 175 is to be transmitted to remote device 180 (FIG. 1) as an e-mail attachment, content generator 120 could convert user-specific content 175 into a file, as well as generate the e-mail used to transmit user-specific content 175. Additionally, content generator 120, in one embodiment, stores generated user-specific content 175 in storage 150 for later retrieval and transmission. For example, if content generator 320 determines that remote device 180 is incapable of receiving user-specific content 175 at that time, content generator 320 could store user-specific content 175 on storage 150 and periodically attempt to deliver user-specific content 175 until it is successfully received.

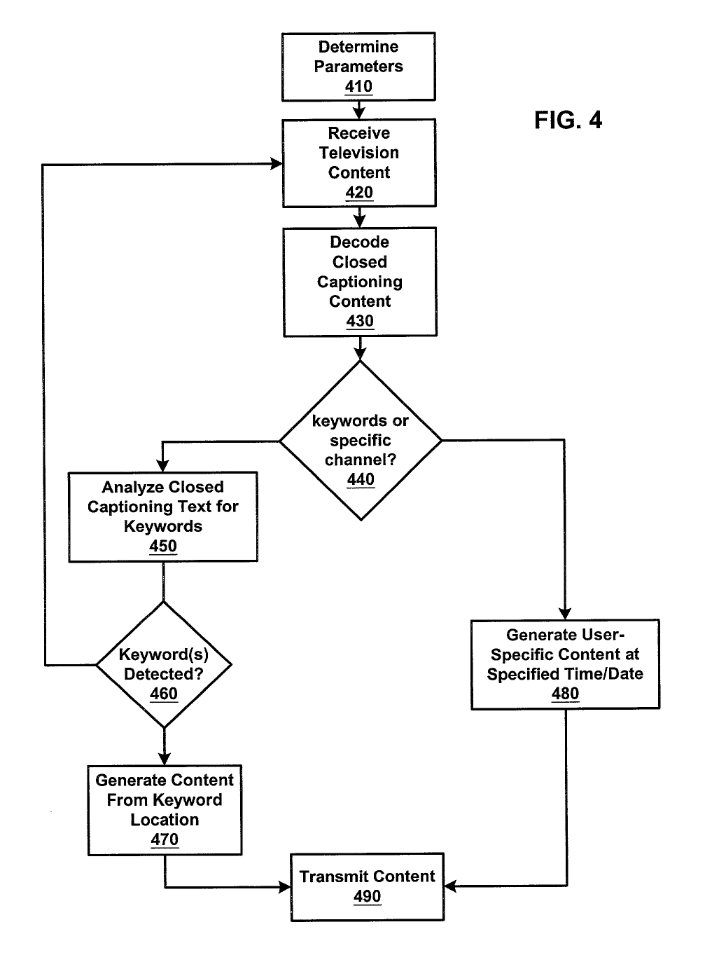

Referring to FIG. 4, a method for generating user-specific content based on closed captioning content is illustrated according to at least one embodiment of the present invention. Method 400 initiates with step 410, where, in one embodiment, parameters 315 (FIG. 3) are determined. Parameters 315, such as keywords to be searched, can be determined by an administrator, preselected from a general profile, and the like. Parameters 315 also can be obtained from user input. As discussed previously, user interface 200 (FIG. 2) is used in one embodiment to obtain parameters 315 from a user. For example, user interface 200 could include a website where user data and preferences, such as receiving device type, keywords to search for, desired specific times/dates, and types of content to be transmitted are input.

In step 420, television content 115 (FIG. 1) is received by content distributor 120. Step 420 can further include the steps of converting television content 115 into an appropriate format, such as from analog to digital, and/or storing television content 115 in storage 150 (FIG. 1). In step 430, television content 115, in one embodiment, is decoded and converted to text as closed captioning text 305 (FIG. 3). Closed captioning text 305 can be sent directly to analysis module 310 (FIG. 3) or stored in storage 150 for retrieval by analysis module 310 at a later time.

In step 440, analysis module 310 (FIG. 3) determines whether user-specific content 175 (FIG. 1) is to be generated based on a keyword search or based on a specified channel, time and/or date, or both. If user-specific content 175 is to be generated based on a keyword search, method 400 proceeds to step 450. If user-specific content 175 is to be generated based on a specified channel, time and/or date, method 400 proceeds to step 480.

In step 450, analysis module 310 (FIG. 3) searches closed captioning text 305 (FIG. 3) for the one or more keywords indicated as part of parameters 315. As discussed previously with reference to FIG. 2, parameters 315 can include a plurality of keywords, wherein the search for the plurality of keywords can be based on a Boolean search, such as searching for any of the plurality of keywords (the Boolean “or”) within closed captioning text 305, or searching for an instance where all of the keywords are present (the Boolean “and”). In addition to inputting one or more keywords, in one embodiment, the user can also indicate one or more channels, such as a television channel or DVD player input channel, to search for the keywords. If the one or more keywords are not located within closed captioning text 305, steps 420-450 are repeated in step 480 on incoming closed captioning text 305 until the keywords are located according to the parameters of the search or until the process is terminated.

If keywords are located in step 460, method 400 proceeds to step 470, where, in one embodiment, user-specific content 175 (FIG. 1) is generated from a portion of television content 115 (FIG. 1) by content generator 320 (FIG. 3) according to the location of the one or more keywords within closed captioning text 305 (FIG. 3). As discussed previously, parameters 315 (FIG. 3) can also include a desired type of content for user-specific content 175, such as a text transcript, a still image, an audio clip, and/or a video clip.

In step 480, content generator 320 (FIG. 3) generates user-specific content 175 (FIG. 1) based on a channel, time and/or date specified by the user, an administrator, and the like. If the specified date and/or time have already passed at the time content generator 320 receives the date and/or time parameters, in one embodiment, content generator 320 retrieves archived data used to generate the corresponding user-specific content 175 from storage 150 (FIG. 1). For example, if a specified date and time have already passed and user-specific content 175 is to include a still image of a specified channel at the specified date and time, content generator 320 could retrieve video content 301 (FIG. 1) stored in storage 150 corresponding to the specified channel, date, and time. Alternately, if the specified date/time parameters have not yet passed at the time content generator 320 receives the parameters, content generator 320 could wait until the specified date/time and then generate user-specific content 175 from the incoming television content 115 (FIG. 1) on a real time basis.

In step 490, user-specific content 175 (FIG. 1), generated in either step 470 or step 480, in one embodiment, is transmitted to remote device 180. Step 490 can include the step of converting user-specific content 175 into the appropriate format. For example, transmitter 170 (FIG. 1) could include a radio transmitter. Accordingly, user-specific content 175 could be converted from a digital format to an analog format for transmission. In the event that remote device 180 is temporarily unable to receive user-specific content 175 at the time of transmission, in one embodiment, user-specific content 175 is stored in step 490 for transmission at later time.

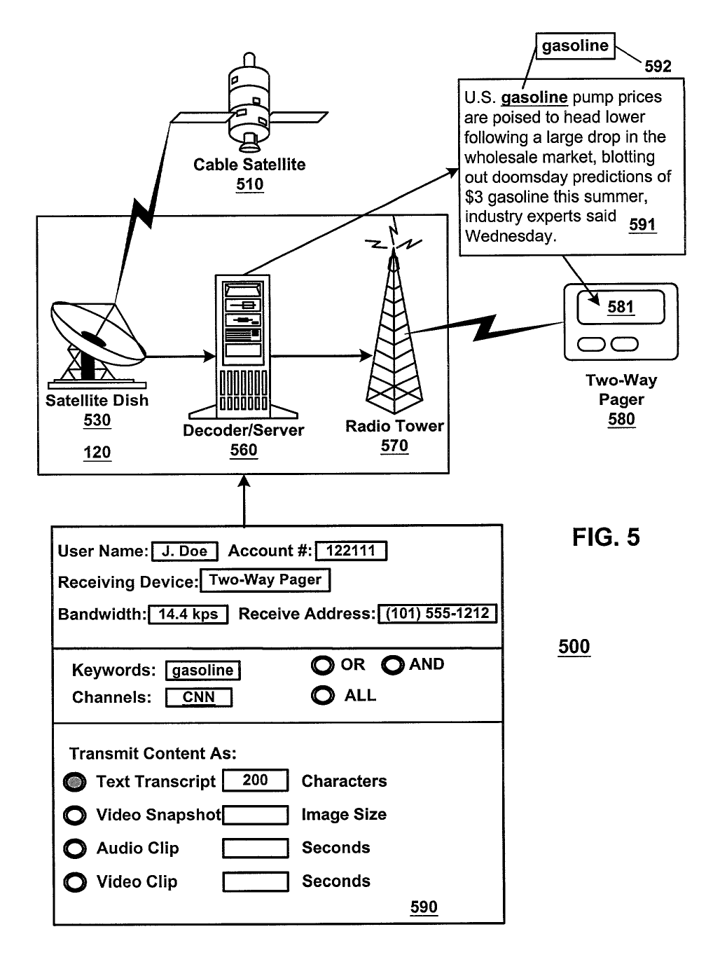

Referring next to FIG. 5, an example embodiment of distribution system 100 is illustrated according to at least one embodiment of the present invention. System 500 (one embodiment of distribution system 100, FIG. 1) includes cable satellite 510 (one embodiment of television source 110, FIG. 1), content distributor 120, and alphanumeric pager 580 (one embodiment of remote device 180, FIG. 1). Content distributor 120 includes satellite dish 530 (one embodiment of receiver 130, FIG. 1), decoder/server 560 (one embodiment of closed captioning decoder 140 and content server 160, FIG. 1), and radio transmitter 570 (one embodiment of transmitter 170, FIG. 1).

In the example illustrated in FIG. 5, a user inputs the following relevant parameters into user interface 200 to generate example parameters 590 (one embodiment of parameters 315, FIG. 3): receiving device—alphanumeric pager; bandwidth-14.4 kilobits per second (kps); receive address-(101) 555-1212; keyword-“gasoline”; channel-26; content type-text; and maximum characters-1500.

Satellite dish 530, in one embodiment, receives a signal representing a plurality of cable television channels (television content 115, FIG. 1) transmitted by cable satellite 510. Cable satellite 510, in this example, converts the signal into separate digital data sets corresponding to each cable television channel and transmits the results to decoder/server 560. Decoder/server 560 selects and continuously decodes the digital data set corresponding to channel 26, as directed by the channel parameter (channel 26) of example parameters 590 to generate a stream of closed captioning text 305 (FIG. 3). Decoder/server 560, in this example, then searches closed captioning text 305 for keyword 591 (“gasoline”). After finding keyword 591 within closed captioning text 305, decoder/server 560 selects a portion of closed captioning text 305 to transmit to alphanumeric pager 580 as user-specific content 175 (FIG. 1). Since, in this example, the user indicated a maximum character length of 200 characters, a 200 character portion of closed captioning text 305 containing keyword 591 is selected and designated as user-specific content 591 (an example of user-specific content 175, FIG. 1). Decoder/Server 560, in this example, formats user-specific content 591 into a proper format (a text transcript) and then transmits it to alphanumeric pager 580 at phone number (101) 555-1212 using radio tower 570. Upon receipt of user-specific content 591, alphanumeric pager 580 displays the text transcript in pager liquid crystal display (LCD) 581.

The various functions and components in the present application may be implemented using an information handling machine such as a data processor, or a plurality of processing devices. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed herein. When a data processor for issuing instructions is used, the instruction may be stored in memory. Such a memory may be a single memory device or a plurality of memory devices. Such a memory device may be read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may be embedded within the circuitry that includes a state machine and/or logic circuitry, or it may be unnecessary because the function is performed using combinational logic. Such an information handling machine may be a system, or part of a system, such as a computer, a personal digital assistant (PDA), a hand held computing device, a cable set-top box, an Internet capable device, such as a cellular phone, and the like.

One of the implementations of the invention is as sets of computer readable instructions resident in the random access memory of one or more processing systems configured generally as described in FIGS. 1-5. Until required by the processing system, the set of instructions may be stored in another computer readable memory, for example, in a hard disk drive or in a removable memory such as an optical disk for eventual use in a compact disc (CD) drive or digital versatile disc (DVD) drive or a floppy disk for eventual use in a floppy disk drive. Further, the set of instructions can be stored in the memory of another processing system and transmitted over a local area network or a wide area network, such as the Internet, where the transmitted signal could be a signal propagated through a medium such as an ISDN line, or the signal may be propagated through an air medium and received by a local satellite to be transferred to the processing system. Such a signal may be a composite signal comprising a carrier signal, and contained within the carrier signal is the desired information containing at least one computer program instruction implementing the invention, and may be downloaded as such when desired by the user. One skilled in the art would appreciate that the physical storage and/or transfer of the sets of instructions physically changes the medium upon which it is stored electrically, magnetically, or chemically so that the medium carries computer readable information. The preceding detailed description is, therefore, not to be taken in a limiting sense, and the scope of the present invention is defined only by the appended claims.

In the preceding detailed description of the figures, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising the steps of:
receiving television content, the television content including closed captioning content;
identifying a first portion of the television content based on the closed captioning content; and
providing content associated with the first portion of the television content to a remote device.

2. The method of claim 1, wherein the step of identifying includes the steps of:
searching the closed captioning content for a keyword; and
selecting the first portion of the television content based on a location of the keyword within the closed captioning content.

3. The method of claim 2, wherein the keyword is indicated by a user.

4. The method of claim 2, wherein the keyword includes one of: a single word, a plurality of words, and a phrase.

5. The method of claim 1, wherein the step of identifying includes the steps of:
obtaining a set of parameters; and
selecting the first portion of the television content based on the set of parameters.

6. The method of claim 5, wherein the set of parameters includes at least one keyword.

7. The method of claim 5, wherein the set of parameters includes parameters specifying a specific time period on a specific channel.

8. The method of claim 5, wherein the set of parameters is specified by a user.

9. The method of claim 8, wherein the set of parameters is specified by the user through a website.

10. The method of claim 1, wherein the content associated with the first portion includes a text transcript based on the closed captioning content.

11. The method of claim 1, wherein the content associated with the first portion includes a still image representative of the first portion of the television content.

12. The method of claim 1, wherein the content associated with the first portion includes an audio clip representative of the first portion of the television content.

13. The method of claim 1, wherein the content associated with the first portion includes a video clip representative of the first portion of the television content.

14. The method of claim 1, wherein the remote device includes a wireless device.

15. The method of claim 1, wherein the remote device includes one of: an alphanumeric pager, a two-way pager, a wireless telephone, and a hand-held computing device.

16. A method comprising the steps of:
locating a keyword within a set of text representative of television content;
selecting a first portion of the television content based on a location of the keyword within the set of text; and
providing content associated with the first portion of the television content to a remote device.

17. The method of claim 16, wherein the set of text is representative of a closed captioning content of the television content.

18. The method of claim 16, wherein the keyword includes one of: a single word, a plurality of words, and a phrase.

19. The method of claim 16, further including the step of obtaining the keyword.

20. The method of claim 19, wherein the keyword is specified by a user.

21. The method of claim 20, wherein the user specifies the keyword using a website.

22. The method of claim 16, wherein the content associated with the first portion includes a text transcript based on the set of text.

23. The method of claim 16, wherein the content associated with the first portion includes a still image representative of the first portion of the television content.

24. The method of claim 16, wherein the content associated with the first portion includes an audio clip representative of the first portion of the television content.

25. The method of claim 16, wherein the content associated with the first portion includes a video clip representative of the first portion of the television content.

26. The method of claim 16, wherein the remote device includes a wireless device.

27. The method of claim 16, wherein the remote device includes one of: an alphanumeric pager, a two-way pager, a wireless telephone, and a hand-held computing device.

28. A system comprising:
a closed captioning decoder to decode a closed captioning content of a television signal to generate a set of text representative of the closed captioning content;
a content server to select a first portion of said television signal based on an analysis of said set of text; and
a transmitter to transmit content associated with said first portion of said television signal to a remote device.

29. The system of claim 28, wherein the analysis of said set of text includes locating a keyword within said set of text.

30. The system of claim 29, wherein the keyword is indicated by a user.

31. The system of claim 29, wherein the keyword includes one of: a single word, a plurality of words, and a phrase.

32. The system of claim 28, wherein the analysis of said set of text includes selecting said first portion of said television signal based on a set of parameters.

33. The system of claim 32, wherein said set of parameters includes parameters specifying a specific time period on a specific channel.

34. The system of claim 32, wherein said set of parameters is specified by a user.

35. The system of claim 34, wherein said set of parameters is specified by the user through a website.

36. The system of claim 28, wherein said content associated with said first portion includes a text transcript based on said closed captioning content.

37. The system of claim 28, wherein said content associated with said first portion includes a still image representative of said first portion of said television signal.

38. The system of claim 28, wherein said content associated with said first portion includes an audio clip representative of said first portion of said television signal.

39. The system of claim 28, wherein said content associated with said first portion includes a video clip representative of said first portion of said television signal.

40. The system of claim 28, wherein said remote device includes a wireless device.

41. The system of claim 28, wherein said remote device includes one of: an alphanumeric pager, a two-way pager, a wireless telephone, and a hand-held computing device.

42. A computer readable medium, said computer readable medium including instructions to manipulate a processor to:
receive television content, the television content including closed captioning content;
identify a first portion of the television content based on the closed captioning content; and
provide content associated with the first portion of the television content to a remote device.

43. The computer readable medium of claim 42, wherein said instructions to manipulate said processor to identify include instructions to manipulate said processor to:
search the closed captioning content for a keyword; and
select the first portion of the television content based on a location of the keyword within the closed captioning content.

44. The computer readable medium of claim 43, wherein the keyword is indicated by a user.

45. The computer readable medium of claim 43, wherein the keyword includes one of: a single word, a plurality of words, and a phrase.

46. The computer readable medium of claim 42, wherein said instructions to manipulate said processor to identify include instructions to manipulate said processor to:
obtain a set of parameters; and
select the first portion of the television content based on the set of parameters.

47. The computer readable medium of claim 46, wherein the set of parameters includes at least one keyword.

48. The computer readable medium of claim 46, wherein the set of parameters includes parameters specifying a specific time period on a specific channel.

49. The computer readable medium of claim 46, wherein the set of parameters is specified by a user.

50. The computer readable medium of claim 49, wherein the set of parameters is specified by the user through a website.

51. The computer readable medium of claim 42, wherein the content associated with the first portion includes a text transcript representative of the first portion of the television content.

52. The computer readable medium of claim 42, wherein the content associated with the first portion includes a still image based on the closed captioning content.

53. The computer readable medium of claim 42, wherein the content associated with the first portion includes an audio clip representative of the first portion of the television content.

54. The computer readable medium of claim 42, wherein the content associated with the first portion includes a video clip representative of the first portion of the television content.

55. The computer readable medium of claim 42, wherein the remote device includes a wireless device.

56. The computer readable medium of claim 42, wherein the remote device includes one of: an alphanumeric pager, a two-way pager, a wireless telephone, and a hand-held computing device.
